(19) United States
(12) Patent Application Publication
(10) Pub. No.: US 2018/0032902 A1
(43) Pub. Date: Feb. 1, 2018

(54) Generating Training Data For A Conversational Query Response System

(71) Applicant: Ford Global Technologies, LLC, Dearborn, MI (US)

(72) Inventors: Lakshmi Krishnan, Santa Clara, CA (US); Kyu Jeong Han, Palo Alto, CA (US); Francois Charette, Tracy, CA (US); Gintaras Vincent Puskorius, Novi, MI (US)

(21) Appl. No.: 15/221,483

(22) Filed: Jul. 27, 2016

(51) Int. Cl. G06N 99/00; G06N 3/08; G06F 17/30

(52) U.S. Cl. CPC G06N 99/005; G06F 17/30684; G06N 3/08

(57) ABSTRACT

Training tuples including text and a question and answer corresponding to the text are input to a machine learning algorithm, such as a deep neural network. A Q&A model is obtained that outputs questions and answers given an input text. The training tuples may be obtained from standardized test such that the text is a question prompt and the questions and answers are based on the prompt. Raw text is input to the Q&A model to obtain second training tuples including a question and an answer. An NLU model is trained according to the second training tuples. The NLU model may then be installed on a consumer device, which will then use the model to respond to conversational queries and provide an appropriate response.

### BACKGROUND

### Field of the Invention

This invention relates to algorithms and systems for processing conversational queries.

### Background of the Invention

Recently, deep neural networks have been very successful in solving complex, large-scale machine perception tasks. Large amounts of labeled data is a key enabler for the success of these deep learning methods. Practical solutions for Natural Language Understanding (NLU) systems with human-like conversational capability require a huge amount of structured data sets of Question And Answer (Q&A) pairs.

The systems and methods disclosed herein provide an improved approach for generating Q&A pairs for use in training a NLU system.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of an environment in which to implement systems and methods in accordance with an embodiment of the present invention;

FIG. 2 is a schematic block diagram of an example computing device suitable for implementing methods in accordance with embodiments of the invention;

FIG. 3 is a schematic block diagram of components for generating training data for an NLU system in accordance with an embodiment of the present invention; and

FIG. 4 is a process flow diagram of a method for generating and using training data for an NLU system in accordance with an embodiment of the present invention.

### DETAILED DESCRIPTION

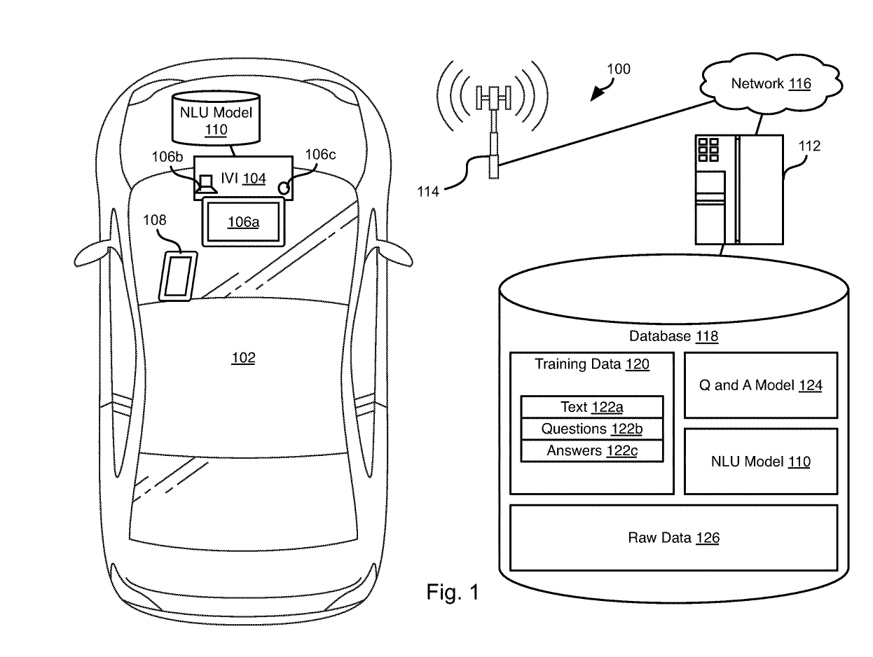

Referring to FIG. 1, an environment 100 in which methods described herein may be implemented may include a vehicle 102 hosting an in-vehicle infotainment (IVI) system 104. The IVI system 104 may have some or all of the attributes of a general purpose computing device. The IVI system 104 may be coupled to a screen 106a that may be embodied as a touch screen, one or more speakers 106b, and one or more microphones 106c.

As known in the art, the IVI system 104 may be programmed to provide an interface for selecting audio content to be played back using the speakers or other audio outputs. Audio content may be selected from one or more sources of audio content coupled to the IVI system 104, such as radio, compact disc (CD) player, and the like. The IVI system 104 may further display video content on the screen 106a or one or more other screens disposed within the vehicle 102. The IVI system 104 may display video content selected from one or more sources of video content, such as a DVD player, paired mobile device, or other source of video data.

The IVI system 104 may further be coupled to one or more systems of the vehicle 102 itself and enable the display of status information for the vehicle 102 and receiving inputs modifying the operation of one or more systems of the vehicle 102 itself, such a climate control, engine operating parameters, and the like.

The IVI system 104 may implement a voice control system whereby an output of the microphone 106c is interpreted into commands for controlling operation of the IVI system 104 or one or more systems of the vehicle 102 through the IVI system 104. For example, the IVI system 104 may implement the FORD SYNC voice control system.

A vehicle 102 typically carries a driver and one or more passengers. A driver or passenger may bring a mobile device 108 in the vehicle 102. The mobile device 108 may pair with the IVI system 104, such as through BLUETOOTH or some other wireless protocol. In some embodiments, control inputs to the IVI system 104 may be received through the mobile device 108 and forwarded to the IVI system 104. In such embodiments, the mobile device 108 may implement a voice control system and include a microphone and speaker for receiving inputs and providing feedback.

In order to facilitate voice control, the IVI system 104 and/or mobile device 108 may host or access a NLU model 110. The NLU model 110 may be trained using question and answer (Q&A) pairs.

In some embodiments, a server system 112 may generate the NLU model 110, which may then be installed on the IVI system 104 or mobile device 108. For example, the NLU model 110 may be installed on the IVI 104 or mobile device 108 at the time of manufacture or may be transmitted to the IVI system 104 or mobile device 108 by the server system 112. Updates to the NLU may also be transmitted to the IVI system 104 or mobile device 108.

Communication with the server system 112 may be facilitated by a network of cellular communication towers 114 in data communication with one or both of the IVI system 104 and mobile device 108. The cellular communication towers may also be in data communication with the server system 112, such as by means of a network 116. The network 116 may be include some or all of a local area network (LAN), wide area network (WAN), the Internet, and any other wired or wireless network connection.

In some embodiments, the server system 112 may host or access a database 118 storing data for generating the NLU model 110 as well as one or more versions of the NLU model 110 itself.

The database 118 may store training data 120. The training data 120 includes a plurality of tuples that each include an original text 122a, a question 122b derived from the text 122a, and an answer 122c derived from the text 122a. For example, the original text 122a may include a prompt for a standardized test question or from training materials for a standardized test, the question 122b may be a question corresponding to the prompt, and the answer 122c may be the answer corresponding to the question 122b. For example, the prompt may be text for a reading comprehension question, a statement of a scenario to which a question relates, or any other text with respect to which questions may be asked.

Examples of standardized tests for which such materials exist may include the American College Testing (ACT) test, Scholastic Assessment Test (SAT), Graduate Record Examination (GRE), Law School Admission Test (LSAT), Graduate Management Admission Test (GMAT), Medical College Admission Test (MCAT), Dental Admission Test (DAT), or any other test for which tests or training materials exist.

The training data 120 is used to train a Question and Answer (Q&A) model 124 as described below. The Q&A model 124 may then process raw data 126 that does not include structured question and answer in order to obtain derived questions and answers. The derived questions and answers are then used to train the NLU model 110 as described below.

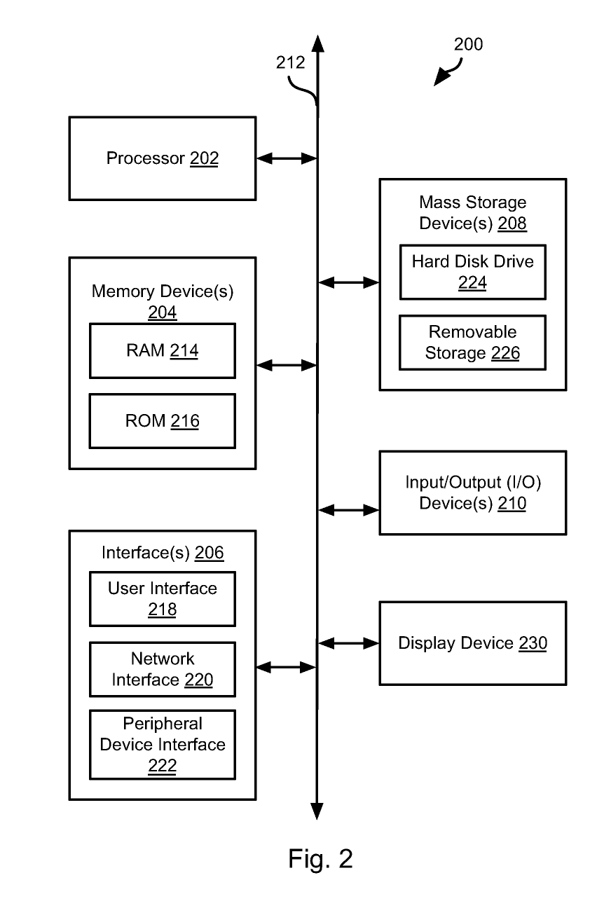

FIG. 2 is a block diagram illustrating an example computing device 200. Computing device 200 may be used to perform various procedures, such as those discussed herein. The IVI system 104, mobile device 108, and server system 112 may have some or all of the attributes of the computing device 200.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

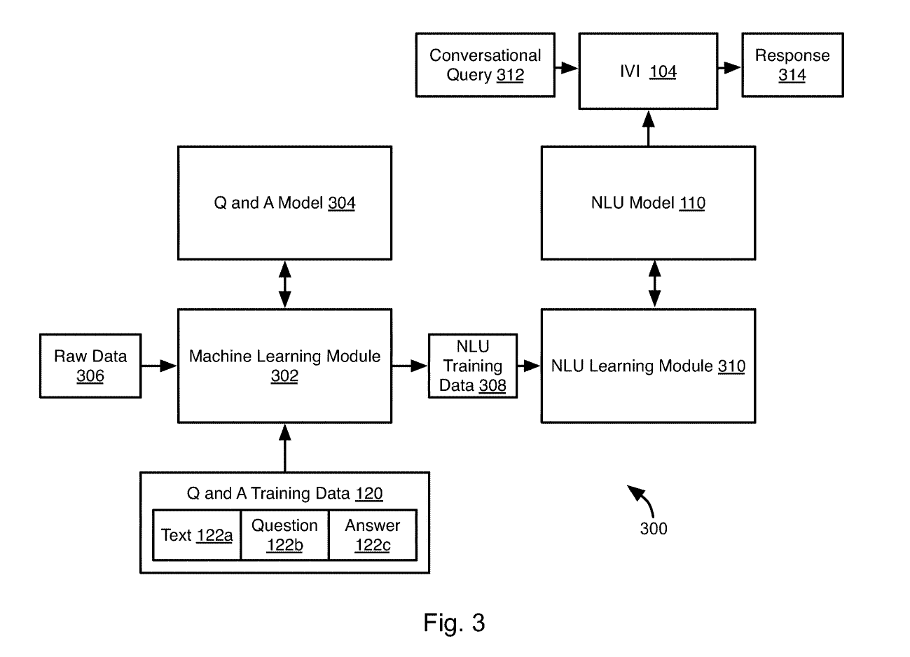

Referring to FIG. 3, the illustrated system 300 may be executed by the server system 112 in order to train and use the NLU model 110. As shown, a machine learning module 302 receives the Q&A training data 120. The machine learning module 302 may implement any machine learning schema known in the art. For example, a deep neural network (DNN) may be used. However, other types of machine learning models may be used, such as a decision tree, clustering, Bayesian network, genetic, or other type of machine learning model.

The machine learning module 302 takes as an input the text 122a of each training tuple (text, question, and answer) and as a desired output the question 122b and answer 122c of the each training tuple. Many tuples may be input to the machine learning module 302 such that a Q&A model 304 is trained to recognize questions and answers from any given text.

Subsequent to training the Q&A model 304, the machine learning module 302, or other module, may then use the Q&A model 304 to process raw data 306. The raw data 306 may be unformatted text that contains information that may be used to generate questions and answers. For example, the raw data 306 may be articles from a reference corpus such as a dictionary, encyclopedia, topical reference book, WIKIPEDIA, or some other source of information. Where the NLU model 110 is used in a vehicle 102, the raw data may be vehicle-specific information, such as an owner's manual, traffic laws, navigational information, or the like. The machine learning module 302 then processes the raw data to extract question and answer tuples that are then used as NLU training data 308.

The NLU training data 308 may then be input into a NLU learning module 310, which processes the NLU training data 308 to train an NLU model 110. Techniques for training a NLU model using formatted Q&A tuples are known in the art. Accordingly, the NLU learning module 310 may use any of these techniques to process the NLU training data 308 and define the NLU model 110.

The NLU learning module 310 may then cause the NLU model 110 to be transmitted to, or installed on, the IVI 104 or mobile device 108. The NLU model 110 may then be used by the IVI 104 or mobile device 108 to receive a conversational query 312 and determine an appropriate response 314. Techniques are known in the art for using an NLU model 110 to respond to conversational queries. Accordingly, any of such techniques may be used.

The conversational query 312 may be received in the form of a voice input that is then processed directly or translated into text and processed according to the NLU model 110. Likewise, the response 314 may be converted into speech and output over speakers.

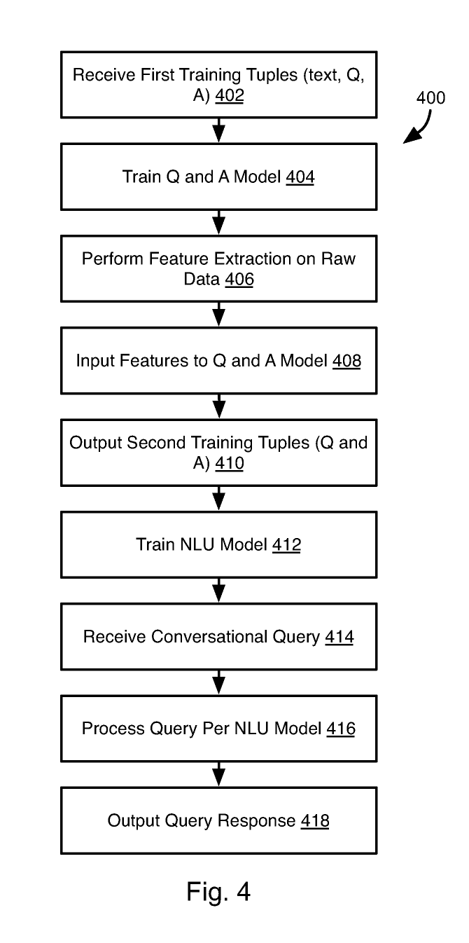

Referring to FIG. 4, the illustrated method 400 may be used to train and use an NLU model 110 for responding to conversational queries. The method 400 may include receiving 402 training tuples that each include a text 122a, question 122b, and answer 122c. As noted above, these may be obtained from standardized tests and/or preparatory materials for such tests.

The method 400 then includes training 404 a Q&A model according to the first training tuples, where the Q&A model is a machine learning model trained according to a machine learning schema using the training tuples. In particular, the text of each tuple is an input and the question and answer of each tuple is the desired output for the tuple.

The method 400 may then include obtaining from raw data second training tuples that each include a question and an answer using the Q&A model. In some embodiments, the raw data is first processed. For example, the method 400 may include performing 406 feature extraction on the raw data. Feature extraction may include identifying concepts included in a text, identifying a part of speech of words in the text, or performing other processing to associate a meaning or role of words or phrases in the text. Performing feature extraction may include using any natural language processing (NLP) technique known in the art. In some embodiments, the text 122a of a first tuple may also be processed to identify features and may be annotated with such features when input to the machine learning algorithm of step 404, i.e. each word or phrase may be annotated with information indicating a concept, part of speech, or other information determined to be associated with that word or phrase.

The method 400 may then including inputting 408 the raw data into the Q&A model as trained at step 404. Inputting 408 the raw data may include inputting 408 the raw data as annotated according to the features identified at step 406. The method then includes outputting 410, as a result of step 406, a set of second training tuples that each includes a question an answer.

The method 400 may then include training 412 the NLU model 110 according to the second training tuples. In particular, the question of a second training tuple may be provided as an input and the answer of the second training tuple provided as a desired output when training the NLU model 110.

Steps 402-412 are advantageously performed by the server system 112 inasmuch as large amounts of data must be processed. The subsequent steps 414-418 may be performed by the server system 112 or a consumer device that has the NLU model 110 installed thereon, such as an IVI system 104, mobile device 108, or any other computing device.

As shown, steps 414-418 may include receiving 414 a conversational query, processing 416 the query using the NLU model, and outputting 418 a response to the query. As noted above, the conversational query may be received as a voice input that is either input directly to the NLU model or translated into text and input to the NLU model. The manner in which the query is processed 416 using the NLU model 110 to obtain a response may include any technique known in the art.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s). At least some embodiments of the disclosure have been directed to computer program products comprising such logic (e.g., in the form of software) stored on any computer useable medium. Such software, when executed in one or more data processing devices, causes a device to operate as described herein.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

What is claimed is:

1. A method for training a query-response model for use in a vehicle, the method comprising, by a computer system:
training a first model using a first plurality of tuples each including text, a question, and an answer;
processing unstructured data using the first model to obtain a second plurality of tuples each including a question and an answer; and
training a second model using the second plurality of tuples.

2. The method of claim 1, further comprising loading the second model onto a consumer computing device.

3. The method of claim 2, wherein the consumer computing device is an in-vehicle infotainment (IVI) system mounted in a vehicle.

4. The method of claim 3, further comprising:
programming the IVI system to receive a query, input the query to the second model, and output a response according to the second model.

5. The method of claim 3, further comprising:
programming the IVI system to input voice queries to the second model and output a response to the query according to the second model.

6. The method of claim 1, wherein the first model is a deep neural network (DNN) model.

7. The method of claim 1, wherein the second model is a deep neural network (DNN) model.

8. The method of claim 1, wherein processing the unstructured data using the first model comprises:
pre-processing, by the computer system, the unstructured data to identify a feature set from within the unstructured data; and
inputting, by the computer system, the feature set to the first model.

9. The method of claim 1, wherein the unstructured data comprises at least one of text and images.

10. The method of claim 1, wherein the first plurality of tuples are derived from test preparation materials for students.

11. A system for training a query-response model comprising:
a first machine learning module including at least one processing device, the machine learning module programmed to:
train a first model using a first plurality of tuples each including text, a question, and an answer;
process unstructured data using the first model to obtain a second plurality of tuples each including a question and an answer; and
a second machine learning module programmed to train a second model using the second plurality of tuples, the second model being a natural language understanding (NLU) model.

12. The system of claim 11, wherein the second machine learning module is further programmed to cause the one or more processors to load the second model onto a consumer computing device.

13. The system of claim 12, wherein the consumer computing device is an in-vehicle infotainment (IVI) system mounted in a vehicle.

14. The system of claim 13, wherein the second machine learning module is further programmed to program the IVI system to receive a query, input the query to the second model, and output a response according to the second model.

15. The system of claim 13 wherein the second machine learning module is further programmed to program the IVI system, to input voice queries to the second model and output a response to the query according to the second model.

16. The system of claim 11, wherein the first model is a deep neural network (DNN) model.

17. The system of claim 11, wherein the second model is a deep neural network (DNN) model.

18. The system of claim 11, wherein the first machine learning module is further programmed to process the unstructured data using the first model by:
pre-processing the unstructured data to identify a feature set from within the unstructured data; and
inputting the feature set to the first model.

19. The system of claim 11, wherein the unstructured data comprises at least one of text and images.

20. The system of claim 11, wherein the first machine learning module is further programmed to derive the first plurality of tuples from test preparation materials for students.
